(19) United States
(12) Patent Application Publication
(10) Pub. No.: US 2010/0286992 A1
(43) Pub. Date: Nov. 11, 2010

(54) Integration of Third-Party Business Applications with Hosted Multi-Tenant Business Software System

(75) Inventors: Alexander Tkatch, Sammamish, WA (US); Amit Kumar, Redmond, WA (US); Manisha Powar, Redmond, WA (US); Preethi Ramarathinam, Bellevue, WA (US); Andreas Hofmann, North Bend, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/463,269

(22) Filed: May 8, 2009

(51) Int. Cl. G06Q 99/00; G06F 15/16; G06F 7/04; G06Q 30/00

(52) U.S. Cl. 705/1.1; 709/203; 726/9

(57) ABSTRACT

A computing device includes a processing unit and a memory with instructions that, when executed by the processing unit, cause the processing unit to create: a business software processing module that manages business application software for a plurality of businesses. The business processing software module comprises a customization module, a registration module and an activation module. The customization module stores and processes definitions for business solutions that permit a business application external to the computing device to be integrated with business application software included on the computing device. The registration module makes the business solutions available to users of the computing device. The activation module generates an activation token and a web page for each request to activate a business solution. For each activation request, the activation module redirects the web page to a URL specified in the business solution definition corresponding to the activation request.

### BACKGROUND

Hosted multi-tenant business software systems provide business applications to customers in an efficient and scalable manner. By hosting business applications on a multi-tenant business software system, a tenant can reduce the hardware, software and configuration costs associated with deploying business applications to customers.

Tenants often customize hosted business applications to satisfy the specific requirements of a business. However, for security reasons hosted multi-tenant business software systems typically limit the extent to which business applications can be customized.

### SUMMARY

Embodiments of the disclosure are directed to a computing device including a processing unit, and a system memory with instructions that, when executed by the processing unit, cause the processing unit to create: a business software processing module that manages business application software for a plurality of businesses. The business software processing module defines one or more business solutions for each of the plurality of businesses. The business processing software module comprises a customization module, a registration module and an activation module. The customization module stores and processes a definition for each of one or more business solutions to be implemented on the computing device. Each of the one or more definitions including customizations to the computing device that permit a business application external to the computing device to be integrated with business application software included on the computing device. The customization module also specifies a URL of a web page to be displayed during an activation process for each of the one or more business solutions to be implemented on the computing device. The registration module registers the one or more business solutions and makes one or more business solutions available to users of the computing device.

The activation module activates one more business solutions when an activation request is received for the one or more business solutions. The activation module generates an activation token for each activation request. The activation token identifies the business application software on the computing device. The activation module generates a web page that identifies the business solution and that identifies a user that initiates an activation request. For each activation request, the activation module redirects the web page to the URL specified in the business solution definition corresponding to the activation request.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for integrating third-party applications with a hosted multi-tenant business software system.

FIG. 2 shows an example business processing software module of an example server computer of FIG. 1 that implements a hosted multi-tenant business software system.

FIG. 3 shows example modules of the business processing module of FIG. 2.

FIG. 4 shows a flowchart of an example method for integrating a third-party application with a hosted multi-tenant business software system.

FIG. 5 shows a flowchart of an example method for activating a business solution on a hosted multi-tenant business software system.

FIG. 6 shows example components of the server computer of FIG. 2.

### DETAILED DESCRIPTION

The present application is directed to systems and methods for integrating third party business applications with business software on a hosted multi-tenant business software system. The third party business applications are implemented on business systems that are external to the hosted multi-tenant business software system. A business solution is defined that describes a customization to the business software on the hosted multi-tenant business software system. The business solution enables the third party business application to be integrated with the business software on the hosted multi-tenant business software system.

One or more business solutions are deployed on the hosted multi-tenant business software system and made available to users of the hosted multi-tenant business software system. A user can be a tenant or a system administrator of the system. The user can select one or more business solutions to be activated.

When activation is initiated for a business solution, an authorization token is generated on the hosted multi-tenant business software system. The authorization token permits the hosted multi-tenant business software system to access information on the external business system and to activate the business solution for a specific tenant.

An example of business software implemented on the hosted multi-tenant business software system is an online customer relationship management system such as Microsoft Dynamics CRM Online from Microsoft Corporation of Redmond, Wash. A customer relationship management system stores information about a business including customers, suppliers, products, orders, etc. and information relating to interactions with customers such as phone calls, e-mails, quotes, etc. An online customer relationship management system stores such information for a plurality of businesses. Each business that has business information hosted on the online customer relationship management system is considered a tenant of the system, i.e. a tenant of a hosted multi-tenant business system.

A hosted multi-tenant business software system such as Microsoft Dynamics CRM Online stores business data using records. The hosted multi-tenant business software system typically provides generic business applications that a tenant can modify. For example, generic applications are typically provided for processing an order, generating an invoice for an order, billing a customer, etc. A customization to a generic business application can include defining new record types, adding attributes to existing record types, modifying existing record attributes, modifying forms, creating new forms and providing user interface customizations.

Customizations to generic solutions may be created by partners of the developer of the hosted multi-tenant business software system. Partners may be businesses or individuals that have knowledge of a specific business area. For example partners with an expertise in shipping and delivery may develop business solutions that can be added to a generic sales solution. Once a business solution is developed it can be registered on the hosted multi-tenant business system and made available to customers of the system. A customer can then select an available solution and activate the solution.

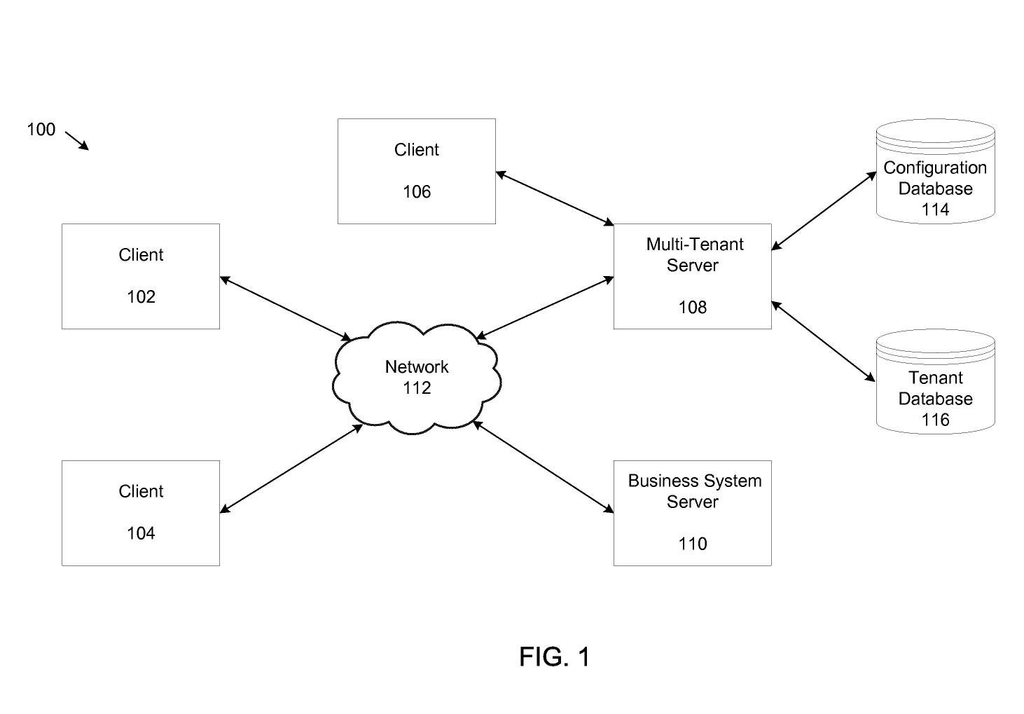

FIG. 1 shows an example system 100 that supports integrating third-party business applications into a hosted multi-tenant business software system. The system 100 includes clients 102, 104, 106, a multi-tenant server 108, a business system server 106 and a network 112. The example system 100 also includes a configuration database 114 and a tenant database 116 used by the multi-tenant server 108. More or fewer clients, servers and databases can be used. In this disclosure, the terms client and client computer are used interchangeably, and the terms server and server computer are used interchangeably.

In example embodiments, client 102 is used by a tenant, client 104 is used by a customer and client 106 is used by an administrator of the hosted multi-tenant business software system. Other embodiments are possible. A tenant is a business for which the business applications are being hosted. A customer is a user that uses a business solution made available on the hosted multi-tenant business software system, for example a user that initiates a web search and is directed to a web page that is called up by the business solution.

Among the plurality of information stored on clients 102, 104, 106 is a client operating system (“OS”) and client applications. The client OS is a program that manages the hardware and software resources of the client system. The client applications utilize the resources of clients 102, 104, 106 to directly perform tasks specified by a user on clients 102, 104, 106. For example, the user may wish to access a business solution on the multi-tenant server 108.

The example multi-tenant server 108 is a server computer that runs a hosted multi-tenant business software system such as Microsoft Dynamics CRM Online. The example multi-tenant server 108 provides business applications for one more tenants of the business system over the Internet.

The business applications provided by the example multi-tenant server 108 are typically in the areas of sales, marketing and customer service. Example sales applications can be provided that permit a customer to search for a product over the Internet, be directed to a web page for a business, order a product, provide billing and shipping information for the product and initiate order processing. An example customer service application could permit a customer to check the status of an order. An example marketing application could provide reports for a marketing campaign. Other example business applications are possible.

The example multi-tenant server 108 interfaces with an example configuration database 114 and with an example tenant database 116. The example configuration database 114 stores configuration information for the business solutions made available and deployed on the example multi-tenant server 108. This includes record types, forms, labels, etc. used by the business solutions. The example tenant database 116 stores information about the specific tenants that implement business solutions on the multi-tenant server 108.

The example business system server 110 is a server computer that is external to the multi-tenant server 108. The business system server 110 is a server computer used by a business system that has a business solution hosted on multi-tenant server 108. For example, business system server 110 may run application software for a shipping and delivery service business. Instead of hosting a shipping and delivery application on business system server 110, the shipping and delivery service business may decide that it is more cost effective to host a shipping and delivery software application on multi-tenant server 108. However, for the shipping and delivery software application to run effectively on multi-tenant server 108, the multi-tenant server 108 needs to access information stored on business system server 110. To effectively access information stored on business system server 110, the example shipping and delivery software application is integrated into application software on business system server 110.

The example configuration database 114 stores configuration information for the business solutions deployed on the example multi-tenant server 108. When a business solution is customized and it is determined that information, for example shipping information, is needed from example business system server 110 in order to implement the business solution, a system administrator updates the example configuration database 114 to reflect that the example business system server 110 is part of the business solution. For example, the updated configuration information can include the type of information needed from business system server 110 and an address for the business system server 110. In example embodiments, the example configuration database 114 may be included in the example multi-tenant server 108. In other example embodiments, the example configuration database 114 may be external to the example multi-tenant server 108.

The example tenant database 116 stores identification information for the tenants of the example multi-tenant server 108. The example tenant database 116 also stores the business solutions activated for each tenant.

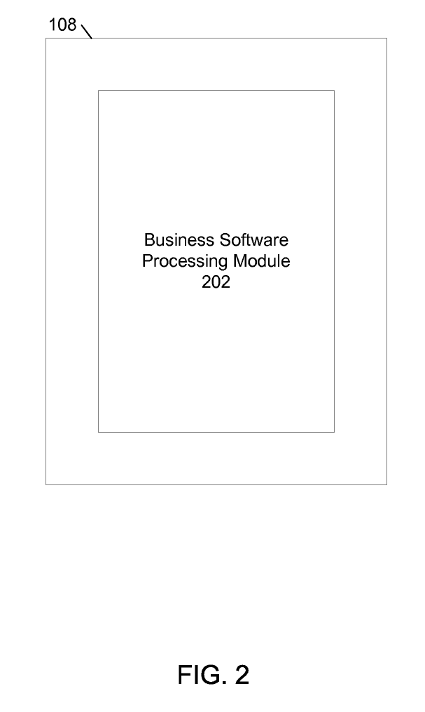

FIG. 2 shows that the example multi-tenant server 108 includes an example business software processing module 202. The example business software processing module 202 includes software that implements a business software application on the example multi-tenant server 108, for example a business software application such as a customer relationship management system.

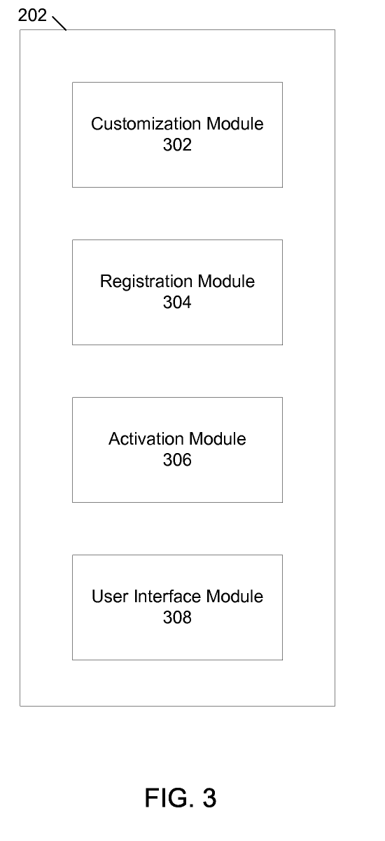

FIG. 3 shows a detailed view of some of the logical modules of the example business software processing module 202. Business software processing module 202 includes example customization module 302, example registration module 304, example activation module 306 and example user interface module 308.

The example customization module 302 processes one or more business solutions that define customizations to the business application software on example multi-tenant server 108. Each business solution includes declarative descriptions of customizations needed to integrate a third party software application with the business application software. A third party software application is a software application that runs on a business system external to multi-tenant server 108. The declarative descriptions of customizations included in the business solution can include defining new record types, adding attributes to existing record types, modifying existing attributes, user interface customizations and work flow customizations. The customizations can also include non-declarative elements such as code blocks and installation scripts that can be executed when a solution is activated for a specific tenant. A code block is a grouping of computer instructions that execute a specific function.

Each customized business solution is defined on a business server that runs the third party software application, for example business system server 110. An example third party software application includes software to ship an order, including calculating the cost of shipment, generating a shipping label and providing a shipping invoice to a customer.

Each customized business solution also includes the URL of a web page used during the activation of the business solution. During the activation process, a client web browser is redirected to a web page on an external business system specified by the URL.

The example registration module 304 registers the business solutions customized on multi-tenant server 108. Each business solution must be registered before it can be deployed. Once a business solution is registered it can be displayed on the user interface of multi-tenant server 108 and made available for selection by a tenant.

The example activation module 306 processes the activation of a business solution. A business solution must be activated before it can be used. To initiate the activation of a business solution, a user of the hosted multi-tenant business software system selects one of the available business solutions on the user interface of multi-tenant server 108. A user may be a tenant on client 102 or an administrator on client 106.

The activation of the business solution is processed on the external business system server, for example business system server 110, on which the third party application for the business solution is located. The activation of the business solution is processed on the external business system server 110 to allow the external business system server 110 to obtain information that can be associated with a tenant on multi-tenant server 108. Examples of information obtained by example business system server 110 include account information, payment information and configuration information.

When the activation process is initiated, the example activation module 306 generates a secure activation token. The secure activation token includes information that identifies the hosted multi-tenant business application running on multi-tenant server 108 and that also identifies the user that initiated the activation process. The secure activation token enforces the security of the activation process. The security of the activation process needs to be enforced because external resources, for example web pages, on external business systems are involved in the activation process. This makes the multi-tenant server 108 subject to security threats such as spoofing. Spoofing is a security threat in which a user or a program successfully masquerades as another.

After the secure activation token is generated, the activation module 306 redirects control to an intermediate redirection web page. The activation module 306 obtains tenant information from the tenant database 116 and includes the tenant information in the intermediate redirection web page. The tenant information includes an identifier for the tenant. The activation module 306 also obtains a record identifier for the business solution and includes the record identifier in the intermediate redirection web page. The activation module 306 may include additional information in the intermediate redirection web page.

After the activation module 306 includes tenant and record identification information in the intermediate redirection web page, the activation module 306 redirects the intermediate redirection web page to the activation web page URL included in the definition of the business solution for the third-party application on example business server 110. At the same time as the activation module 306 redirects the intermediate redirection page to the activation page URL, the activation module 306 sends the secure activation token to example business server 110.

In example embodiments, when the example business server 110 receives the secure activation token, the example business server 110 calls back to the example multi-tenant server 108 to verify that the secure activation token is valid. The call back comprises the example business server 110 calling a method exposed by an application program interface on multi-tenant server 108.

In example embodiments, when a determination is made that the secure activation token is valid, the example business server 110 includes additional information in the activation web page and redirects the activation web page back to multi-tenant server 108. The additional information that the example business server 110 includes in the activation web page are additional items the business server 110 requires from the user that initiated the activation processes. Such items may include credit card information, shipping information, terms and conditions relating to the solution, etc.

After the user enters the required information in the activation web page, the activation module 306 redirects the activation web page back to business server 110. When the business server 110 validates the information in the activation web page, the business server 110 calls back to multi-tenant server 108 to activate the business solution. The call back comprises the example business server 110 calling another method exposed by an application program interface on multi-tenant server 108. When the business solution is activated, the activation module 206 updates the tenant database 116 to enable use of the business solution.

Once a business solution is activated, the hosted multi-tenant business software system provides an application program interface for the external business system associated with the business solution. The application program interface exposes methods that enable the external business system to access information on the hosted multi-tenant business software system without any additional authentication. For example, when a business solution is activated, an external business system can obtain status for the business solution, activate the business solution for a specific tenant and obtain a list of tenants that have activated the business solution. The accessing of other types of information by the external business system is possible.

The example user interface module 308 provides a user interface for the hosted multi-tenant business software system. The user interface permits a user of the hosted multi-tenant business software system to create records and access information stored on the system. When a business solution is activated, the behavior of elements of the user interface may change as a result. For example, double clicking on a record opens a web page on an external business system when a business solution is activated and opens a standard web page from the hosted multi-tenant business software system when the business solution is not activated.

The secure activation token is time constrained and includes an expiration period. At the end of the expiration period, the secure activation token is deactivated and no longer valid. The time constraint on the secure activation token provides an additional level of security.

One example of a business solution that can be customized by the example business software processing module 202 is a search engine advertisement business solution. Search engine advertisement enables users, for example a user on client 104, to define marketing campaigns based on a set of keywords. Users of Internet search engines looking for specific keywords are directed to a set of web pages defined as part of the marketing campaign.

Because search engine advertisement is expensive, businesses that implement search engine advertisement campaigns are typically interested in statistics about the campaign. For example, the number of hits per keyword, the number of sales that results from an advertisement, etc. are important pieces of information. If businesses that implement search engine advertisement campaigns also are tenants of an online customer relationship management system, the businesses could develop a customized business solution that automatically inputs the results of customer searches into the hosted multi-tenant business software system.

To develop such a customized business solution, a search engine advertisement business, for example a search engine advertisement business implemented on business system server 110, defines a business solution. The business solution can include defining new forms that are displayed as a result of a keyword hit. The business solution also can include new records to store data such as the number of hits per keyword, the revenue generation per keyword hit, etc. When the search engine advertisement business solution is defined, the business solution is registered by the example registration module 304 and deployed on the user interface of the online customer relationship management system on multi-tenant server 108. One or more tenants of the online customer relationship management system then activate the search engine advertisement business solution via the example activation module 306.

The example activation module 306 generates a secure activation token and sends the secure activation token to business system server 110. When the business system server 110 receives the secure activation token, the business system server 110 calls back to the multi-tenant server 108 to verify that the secure activation token is valid. When a determination is made that the secure activation token is valid, the example business server 110 redirects an activation web page back to multi-tenant server 108. The activation web page includes information needed to activate the search engine advertisement business solution. For example, the activation web page typically includes an identifier for each tenant on the multi-tenant server 108 for which the search engine advertisement business solution is activated.

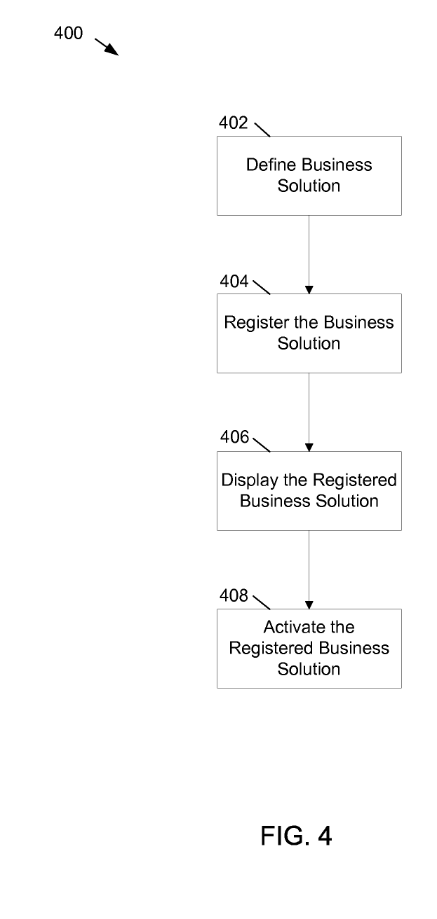

FIG. 4 shows an example flowchart for a method 400 for integrating a third party application with a hosted multi-tenant business software system. At operation 402, a business solution is defined at the example customization module 302. The definition of the business solution includes a declarative description of any customizations that need to be performed at multi-tenant server 108 to enable integration of a third party business application at an business system server, for example business system server 110, that is external to multi-tenant server 108. The customizations can include defining new record types, adding attributes to record types, modifying existing attributes and user interface customizations such as new forms. Other customizations are possible. The definition of the business solutions can also include non-declarative elements such as code blocks and installation scripts that can be executed when the business solution is activated for a specific tenant. In addition, the definition of the business solution also includes the URL of an external business system server on which an activation web page of the business solution can be displayed. The external business system server is the business system server that runs the third party business application.

After the business solution is defined, at operation 404, the example registration module 304 registers the business solution at the example multi-tenant server 108. Once a business solution is registered, at operation 406, the registered business solution is displayed on a user interface of the multi-tenant server 108 and made available to users of the hosted multi-tenant business software system.

After the business solution is defined, registered and displayed at the multi-tenant server 108, at operation 408, the registered business solution is activated. A business solution is selected for activation when a user of the hosted multi-tenant business system, typically a tenant or an administrator, for example a tenant on client 102 or an administrator on client 106, selects the business solution from a list of available business solutions on the user interface of multi-tenant server 108. The activation of the business solution enables the business solution on multi-tenant server 108.

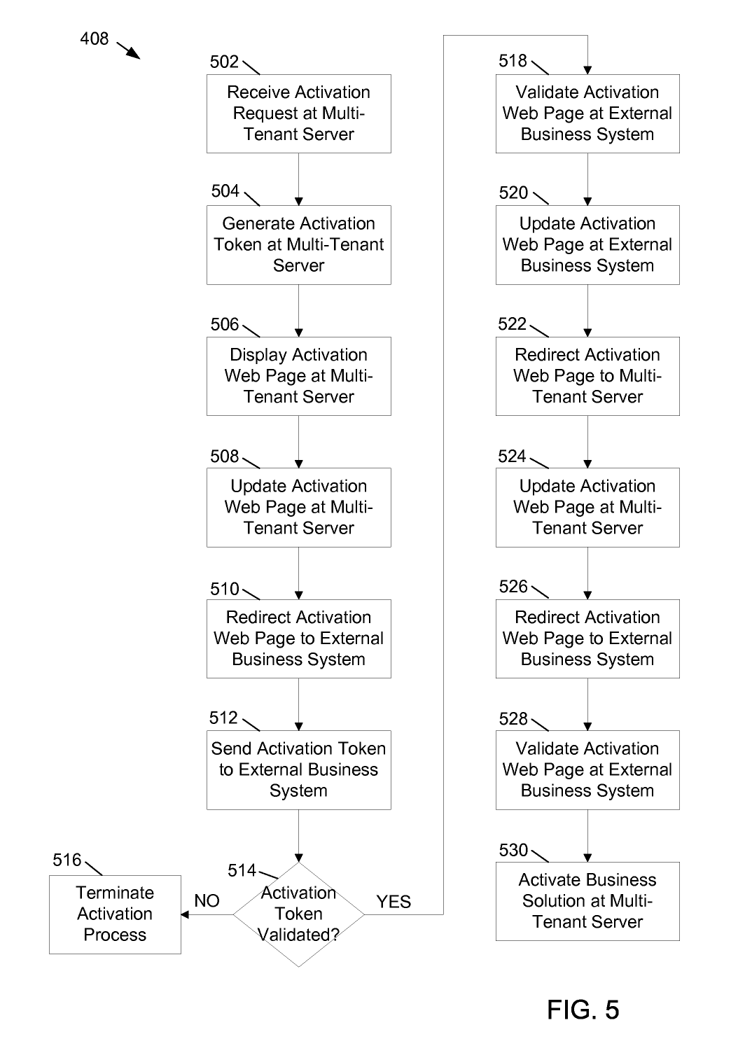

FIG. 5 shows a flowchart of example operation 408, activating the registered business solution. At operation 502, the example activation module 306 receives a request on multi-tenant server 108 to activate a business solution. The activation request is typically made by a user, for example a tenant on client 102 or an administrator on client 106 selecting the business solution from a list of available business solutions. The list of available business solutions typically is displayed on a user interface of multi-tenant server 108. A business solution is typically selected for activation by clicking the business solution on the user interface.

After the activation request is made, at operation 504, the activation module 306 generates a secure activation token on multi-tenant server 108. The secure activation token is a software element that includes an identifier for the multi-tenant server 108. The secure activation token is used to validate the activation request at an external business system server.

In addition to generating the secure activation token, at operation 506 the activation module 306 displays an activation web page at the multi-tenant server 108. The activation web page includes fields for identifying the user initiating the activation request and that includes fields for identifying details about the business solution. At operation 508, a user of the hosted multi-tenant business system, typically a tenant on client 102 or an administrator on client 106, updates the fields of the activation web page with identification information.

After the activation web page is updated, at operation 510, the activation web page is redirected to the redirection address on the external business system, for example business system server 110, specified by the URL included in the definition of the business solution. In addition, at operation 512, the secure activation token is sent to example business system server 110.

At operation 514, the external business system determines whether the secure activation token is valid. When it is determined that the secure activation token is not valid, the external business system informs multi-tenant server 108 that the secure activation is not valid. At operation 516, the activation module 306 terminates the activation process for the business solution. When it is determined that the secure activation token is valid, at operation 518, the external business system validates the identification information on the redirected activation page. After the identification information is validated, at operation 520, the external business system updates the redirected activation web page with additional information needed from the user that initiated the activation of the business solution. For example, business system server 110 may specify information such as a credit card number or an authorization number, etc.

After the external business system updates the activation web page, at operation 522, the activation web page is redirected back to multi-tenant server 108. At operation 524, the user at multi-tenant server 108, for example a tenant on client 102 or an administrator on client 106, updates the redirected activation web page with the information required on the activation web page. After the user updates the activation web page with the required information, at operation 526, multi-tenant server 108 redirects the activation web page back to the external business system.

After the updated activation web page is redirected back to the external business system, at operation 528, the information on the updated activation web page is validated by the external business system. When the updated activated web page is validated by the external business system, at operation 530, the external business system uses a method exposed by an application programming interface of multi-tenant server 108 to inform the activation module 306 that the updated web page is validated and to activate the business solution on the multi-tenant server 108.

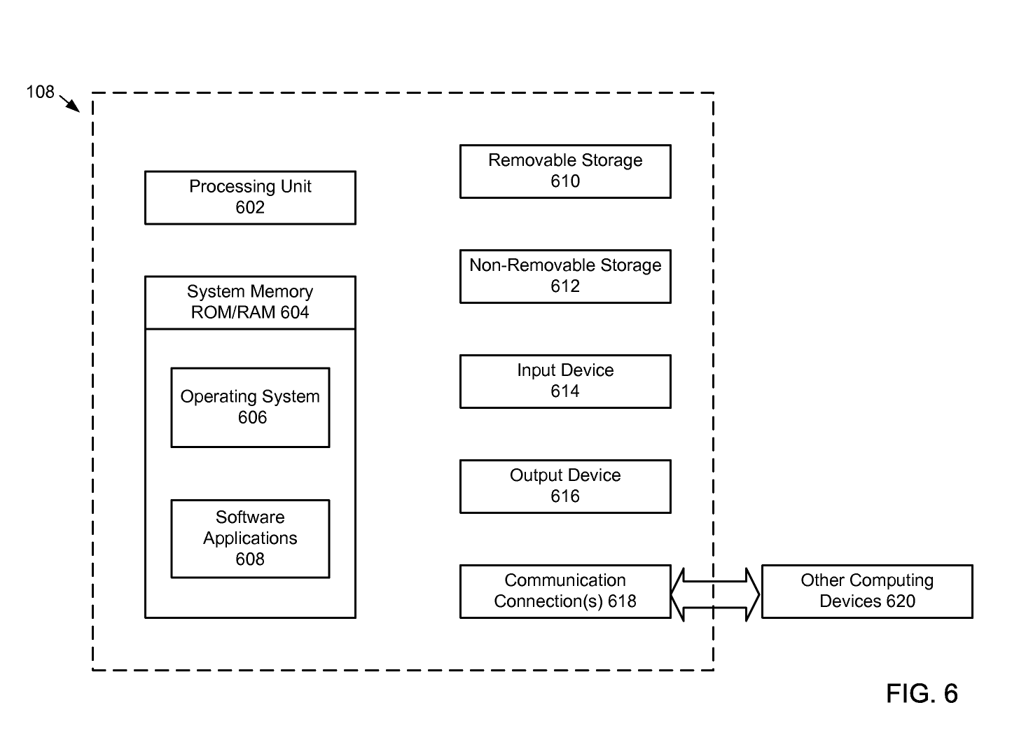

With reference to FIG. 6, example components of server 108 are shown. In example embodiments, the server 108 is a computing device, such as a server computer. The server 108 can include input/output devices, a central processing unit (“CPU”), a data storage device, and a network device.

In a basic configuration, the computing device 108 typically includes at least one processing unit 602 and system memory 604. Depending on the exact configuration and type of computing device, the system memory 604 may be volatile (such as RAM), non-volatile (such as ROM, flash memory, etc.) or some combination of the two. System memory 604 typically includes an operating system 606 suitable for controlling the operation of a networked personal computer, such as the WINDOWS® operating systems from MICROSOFT CORPORATION of Redmond, Wash. or a server, such as Windows SharePoint Server 2007, also from MICROSOFT CORPORATION of Redmond, Wash. The system memory 604 may also include one or more software applications 608 and may include program data.

The computing device 108 may have additional features or functionality. For example, the computing device 108 may also include additional data storage devices (removable and/or non-removable) such as, for example, magnetic disks, optical disks, or tape. Such additional storage is illustrated in FIG. 6 by removable storage 610 and non-removable storage 612. Computer storage media may include volatile and nonvolatile, removable and non-removable media implemented in any method or technology for storage of information, such as computer readable instructions, data structures, program modules, or other data. System memory 604, removable storage 610 and non-removable storage 612 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 108. Any such computer storage media may be part of device 108. Computing device 108 may also have input device(s) 614 such as keyboard, mouse, pen, voice input device, touch input device, etc. Output device(s) 616 such as a display, speakers, printer, etc. may also be included. These devices are well known in the art and need not be discussed at length here.

The computing device 108 may also contain communication connections 618 that allow the device to communicate with other computing devices 620, such as over a network in a distributed computing environment, for example, an intranet or the Internet. Communication connection 618 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The various embodiments described above are provided by way of illustration only and should not be construed to limiting. Various modifications and changes that may be made to the embodiments described above without departing from the true spirit and scope of the disclosure.

1. A method for activating a business solution on an Internet-based multi-tenant business software system, the method comprising:
defining a business solution on a first server computer, the first server computer implementing a hosted multi-tenant business software system, the first server computer hosting
one or more business solutions for one or more tenants of the hosted multi-tenant business software system, the definition of the business solution including customizations to the hosted multi-tenant business system, the definition for the business solution including a URL for a web page on a second server computer;
after defining the business solution, registering the business solution on the first server computer;
after registering the business solution on the first server computer, receiving a request from a user the hosted multi-tenant business software system to activate the business solution on the first server computer;
after receiving the request to activate the business solution, generating an activation token for the business solution on the first server computer and sending the activation token to the second server computer;
after receiving the request to activate the business solution, activating a web page on the first server computer;
after activating the web page, updating the web page with information obtained from a user of the multi-tenant business software system;
after updating the web page with information obtained from a user of the multi-tenant business software system, redirecting the web page to the URL included in the definition of the business solution;
receiving a validated activation token from the second server computer;
after receiving the validated activation token from the second server computer and after redirecting the web page to the URL included in the definition of the business solution, receiving a notification from the second server computer that the business solution is validated at the second server computer; and
after receiving the notification from the second server computer indicating that the business solution is validated, activating the business solution on the multi-tenant business software system.

2. The method of claim 1, further comprising the activation token including information that identifies the multi-tenant business software system to the second server computer.

3. The method of claim 1, wherein updating the web page with information obtained from a user of the multi-tenant business software system further comprises providing information that identifies the user to the second server computer.

4. The method of claim 3, further comprising the information including authentication credentials needed by the second server computer to validate the user.

5. The method of claim 1, wherein receiving a request from a user the hosted multi-tenant business software system to activate the business solution on the first server computer further comprises selecting the business solution to be activated on a user interface of the first server computer;

6. The method of claim 1, further comprising after redirecting the web page to the URL included in the definition of the business solution, receiving the redirected web page at the first server computer, the redirected web page received at the first server computer including additional information required by the second server computer.

7. The method of claim 6, further including updating the redirected web page received at the first server computer with the additional information required by the second server computer and redirecting the web page back to the second server computer.

8. The method of claim 1, wherein the customizations to the hosted multi-tenant business system permit a business application on the second server computer to be integrated into the hosted multi-tenant business system.

9. The method of claim 8, wherein the business application on the second server computer is a search engine advertisement business application.

10. The method of claim 1, wherein the first server computer exposes an application programming interface to the second server computer.

11. The method of claim 10, wherein receiving a notification from the second server computer that the business solution is validated at the second server computer further comprises calling a method exposed by the application programming interface.

12. The method of claim 1, further comprising the authentication token having an expiration period.

13. The method of claim 12, further comprising the authentication token being deactivated at the end of the expiration period.

14. The method of claim 1, wherein activating the business solution further comprises changing the operating behavior of the hosted multi-tenant business system.

15. A computing device, comprising:
a processing unit;
a system memory connected to the processing unit, the system memory comprising instructions that, when executed by the processing unit, cause the processing unit to create:
a business software processing module that manages business application software for a plurality of businesses, the business software processing module defining one or more business solutions for each of the plurality of businesses, the business software processing module comprising:
a customization module that stores and processes a definition for each of one or more business solutions to be implemented on the computing device, each of the one more definitions including customizations to the computing device that permit a business application external to the computing device to be integrated with business application software included on the computing device, the customization module specifying a URL of a web page to be displayed during an activation process for each of the one or more business solutions to be implemented on the computing device;
a registration module that registers the one or more business solutions and that makes one or more business solutions available to users of the computing device; and
an activation module that activates one or more business solutions when an activation request is received for the one or more business solutions, the activation module generating an activation token for each activation request, the activation token identifying the business application software on the computing device, the activation module generating a web page that identifies the business solution and that identifies a user that initiates an activation request, for each activation request the activation module redirecting the web page to the URL specified in the business solution definition corresponding to the activation request.

16. The computing device of claim 15, wherein the activation module activates a business solution when a validated authentication token is received for the business solution and when a validation is received for information included on the web page.

17. The computing device of claim 16, wherein the validation received for information included on the web page is based on a call to a method exposed by an application programming interface included on the computing device.

18. The computing device of claim 15, wherein the definition of at least one business solution includes defining one or more new record types, adding attributes to existing record types or modifying attributes of existing record types.

19. The computing device of claim 15, wherein the definition of at least one business solution includes customizing the user interface of the business application software.

20. A computer-readable data storage medium comprising instructions that, when executed by a processing unit of an electronic computing device, cause the processing unit to:
define a business solution on a first server computer, the first server computer implementing a hosted multi-tenant business software system, the first server computer hosting
one or more business solutions for one or more tenants of the hosted multi-tenant business software system, the definition of the business solution including customizations to the hosted multi-tenant business system, the definition for the business solution including a URL for a web page on a second server computer;
after defining the business solution, register the business solution on the first server computer;
after registering the business solution on the first server computer, receive a request from a user the hosted multi-tenant business software system to activate the business solution on the first server computer;
after receiving the request to activate the business solution, generate an activation token for the business solution on the first server computer, the activation token including information that identifies the multi-tenant business software system to the second server computer;
after generating the activation token, send the activation token to the second server computer;
after receiving the request to activate the business solution, activate a web page on the first server computer;
after activating the web page, update the web page with information obtained from a user of the multi-tenant business software system, the information identifying the user to the second server computer;
after updating the web page with information obtained from a user of the multi-tenant business software system, redirect the web page to the URL included in the definition of the business solution;
after redirecting the web page to the URL included in the definition of the business solution, receive an updated web page at the first server computer, the updated web page including information required by a second server computer;
include the information required by the second server computer in the updated web page and redirect the web page to the URL included in the definition of the business solution;
receive a validated activation token from the second server computer;
after receiving the validated activation token from the second server computer and after redirecting the web page to the URL included in the definition of the business solution, receive a notification from the second server computer that the business solution is validated at the second server computer, the notification being a call to a method exposed by an application programming interface on the first server computer; and
after receiving the notification from the second server computer indicating that the business solution is validated, activate the business solution on the multi-tenant business software system.
